(19) United States
(12) Patent Application Publication
(10) Pub. No.: US 2012/0154606 A1
(43) Pub. Date: Jun. 21, 2012

(54) CLOUD SERVER, MOBILE TERMINAL AND REAL-TIME COMMUNICATION METHOD

(75) Inventors: Zhou Ye, Foster City, CA (US); Pei-Chuan Liu, Taipei City (TW)

(73) Assignee: BLUESPACE CORPORATION, APIA (WS)

(21) Appl. No.: 13/271,236

(22) Filed: Oct. 12, 2011

(30) Foreign Application Priority Data
Dec. 20, 2010 (CN) 201010609792.4

(51) Int. Cl. H04N 5/225; G06K 9/00; G06F 15/16; G06K 9/46

(52) U.S. Cl. 348/207.1; 382/195; 382/104; 382/100; 709/219; 348/E05.024

(57) ABSTRACT

A cloud server includes a computing service provider, a communication unit and a processing unit. The computing service provider is configured to provide a computing service. The communication unit is configured to receive from a mobile terminal a request for the computing service that allows the mobile terminal to use at least one first image provided by a remote device supporting the computing service. The processing unit is configured to generate at least one second image for transmitting to the remote device based on the request and the at least one first image.

### BACKGROUND OF THE INVENTION

1. Field of the Invention

The present invention relates to a cloud computing system, and more particularly, to a system and a method allow for real time communication between a cloud server and a mobile terminal.

2. Description of the Prior Art

The cloud computing provides computation, software, data access, and storage services that do not require user-end knowledge of the physical location and configuration of the system that delivers the services. However, the current cloud server system does not provide a whole service to the user, that is, the user-end electronic device still requires a powerful processor to process the data, causing the user-end electronic device has a great manufacturing cost.

### SUMMARY OF THE INVENTION

It is therefore an objective of the present invention to provide a system and a method allow for real time communication between a cloud server and a mobile terminal, which can provide a whole service to the user to make the user of the mobile terminal does not need a powerful processor, to solve the above-mentioned problems.

According to one embodiment of the present invention, a cloud server includes a computing service provider, a communication unit and a processing unit. The computing service provider is configured to provide a computing service. The communication unit is configured to receive from a mobile terminal a request for the computing service that allows the mobile terminal to use at least one first image provided by a remote device supporting the computing service. The processing unit is configured to generate at least one second image for transmitting to the remote device based on the request and the at least one first image.

According to another embodiment of the present invention, a real-time communication method comprising: receiving a request for a computing service from a mobile terminal; receiving at least one first image from a remote device via a network; analyzing the at least one first image to generate at least one second image according to the request, where contents of the second image are different from contents of the first image; and transmitting the at least one second image to the mobile terminal.

According to another embodiment of the present invention, a mobile terminal comprises a communication unit and a display unit. The communication unit is configured to transmit a request for a computing service to a cloud server that allows the mobile terminal to use at least one first image provided by a remote device supporting the computing service and receive at least one second image generated in the cloud server based on the request and the at least one first image. The display unit is configured to display the at least one second image.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a real-time communication system according to one embodiment of the present invention.

FIG. 2 is a flowchart of a real-time communication method according to one embodiment of the present invention.

FIG. 3 is a flowchart of a real-time communication method according to another embodiment of the present invention.

FIG. 4 is a diagram illustrating a real-time communication system according to another embodiment of the present invention.

FIG. 5 is a flowchart of a real-time communication method according to another embodiment of the present invention.

FIG. 6 is a diagram illustrating a real-time communication system according to another embodiment of the present invention.

FIG. 7 is a flowchart of a real-time communication method according to another embodiment of the present invention.

FIG. 8 is a flowchart of a general concept of a real-time communication method according to another embodiment of the present invention.

### DETAILED DESCRIPTION

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is electrically connected to another device, that connection may be through a direct electrical connection, or through an indirect electrical connection via other devices and connections.

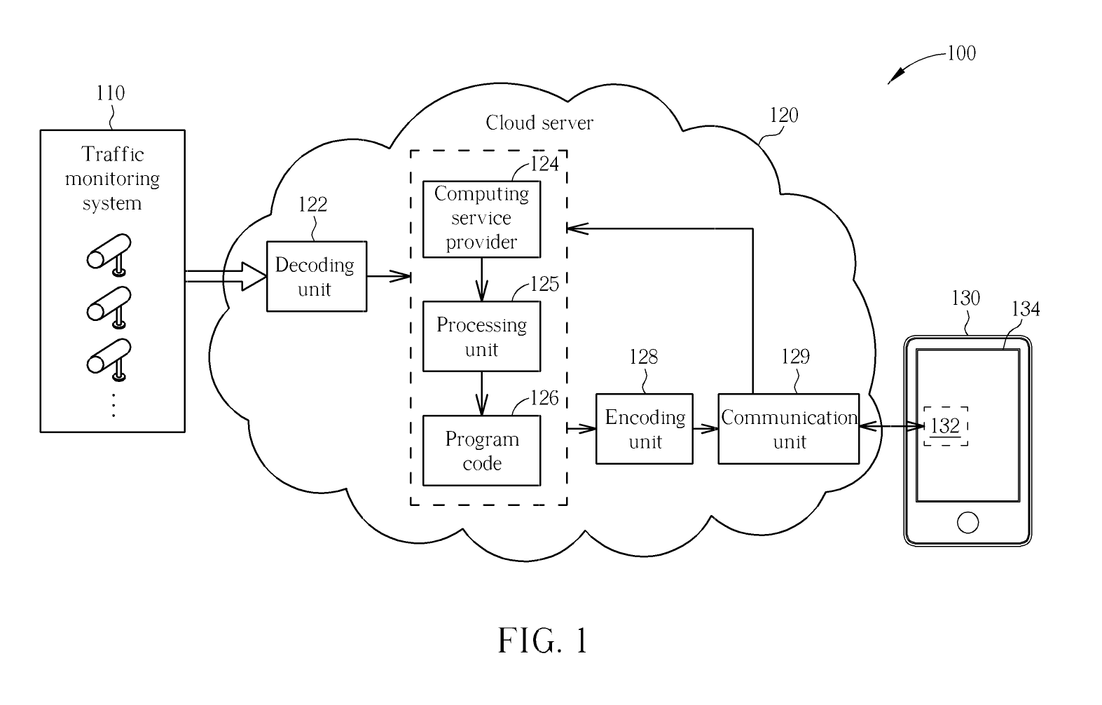

Please refer to FIG. 1, which shows a real-time communication system 100 according to one embodiment of the present invention. As shown in FIG. 1, the real-time communication system 100 comprises a traffic monitoring system 110, a cloud server 120 and a client-end mobile terminal 130, where the cloud server 120 comprises a decoding unit 122, a computing service provider 124, a processing unit 125, a program code 126, an encoding unit 128 and a communication unit 129; and the client-end mobile terminal 130 comprises a communication unit 132 and a display unit 134. In addition, the traffic monitoring system 110 has a plurality of cameras positioned on streets/roads, respectively, or positioned on/inside the moving cars, respectively.

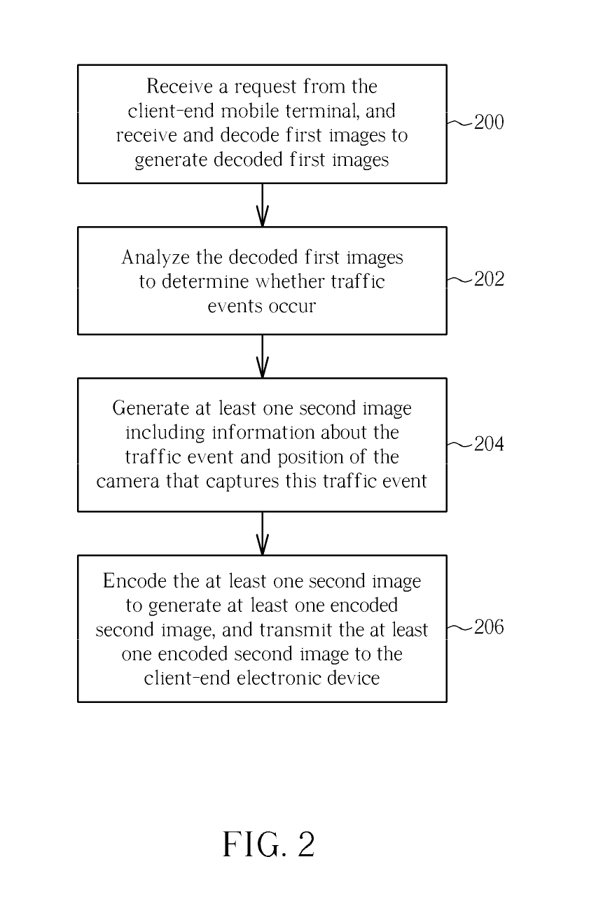

Please refer to FIG. 1 and FIG. 2 together. FIG. 2 is a flowchart of a real-time communication method according to one embodiment of the present invention. The steps shown in FIG. 2 are performed by the processor 125 when the program code 126 is executed by the processor 125. Referring to FIG. 2, the flow is described as follows:

In Step 200, the communication unit 129 receives a request from the client-end mobile terminal 130 for a computing service that allows the client-end mobile terminal 130 to use a plurality of first images provided by traffic monitoring system 110, and the decoding unit 122 receives and decodes the plurality of first images captured by the cameras of the traffic monitoring system 110 via a network to generate a plurality of decoded first images, where the first images contain photographed data about real-time street images. Then, in Step 202, the processing unit 125 analyzes the decoded first images to determine whether traffic events occur at positions where the cameras are disposed based on the request, where the traffic event can be traffic jam, traffic accident or any other traffic condition. Then, in Step 204, the processing unit 125 generates at least one second image including information about the traffic event and position of the camera that captures this traffic event. Then, in Step 206, the encoding unit 128 encodes the at least one second image to generate at least one encoded second image, and transmits the at least one encoded second image to the client-end electronic device 130 via the communication unit 129 and network, where the client-end electronic device 130 merely decodes the at least one encoded second image and directly displays the at least one second image without processing or modifying the second image.

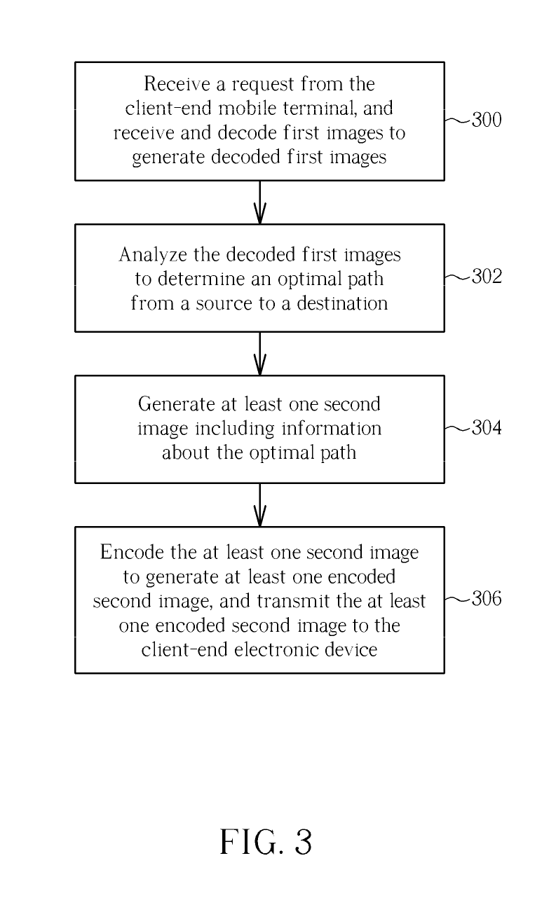

Please refer to FIG. 1 and FIG. 3 together. FIG. 3 is a flowchart of a real-time communication method according to another embodiment of the present invention. The steps shown in FIG. 3 are performed by the processing unit 125 when the program code 126 is executed by the processing unit 125. Referring to FIG. 3, the flow is described as follows:

In Step 300, the communication unit 129 receives a request from the client-end mobile terminal 130 for a computing service that allows the client-end mobile terminal 130 to use a plurality of first images provided by traffic monitoring system 110, and the decoding unit 122 receives and decodes a plurality of first images captured by the cameras of the traffic monitoring system 110 via a network to generate a plurality of decoded first images, where the first images contain photographed data about real-time street images. Then, in Step 302, the processing unit 125 analyzes the decoded first images to determine an optimal path from a source to a destination based on the request. Then, in Step 304, the processing unit 125 generates at least one second image including information about the optimal path. Then, in Step 306, the encoding unit 128 encodes the at least one second image to generate at least one encoded second image, and transmits the at least one encoded second image to the client-end electronic device 130 via the network, where the client-end electronic device 130 merely decodes the at least one encoded second image and directly displays the at least one second image without processing or modifying the second image.

In the embodiments shown in FIG. 2 and FIG. 3, the cloud server 120 can finish all the analyzing and computing steps, and generate at least one second image that shows all the required information. Therefore, the client-end electronic device 130 merely needs a decoding circuit and a displayer to show the second image, and does not need a powerful processor to process the second image (e.g. processing the data from the cloud server 120 with the map information stored in the client-end electronic device 130), and the manufacturing cost of the client-end electronic device 130 can be decreased.

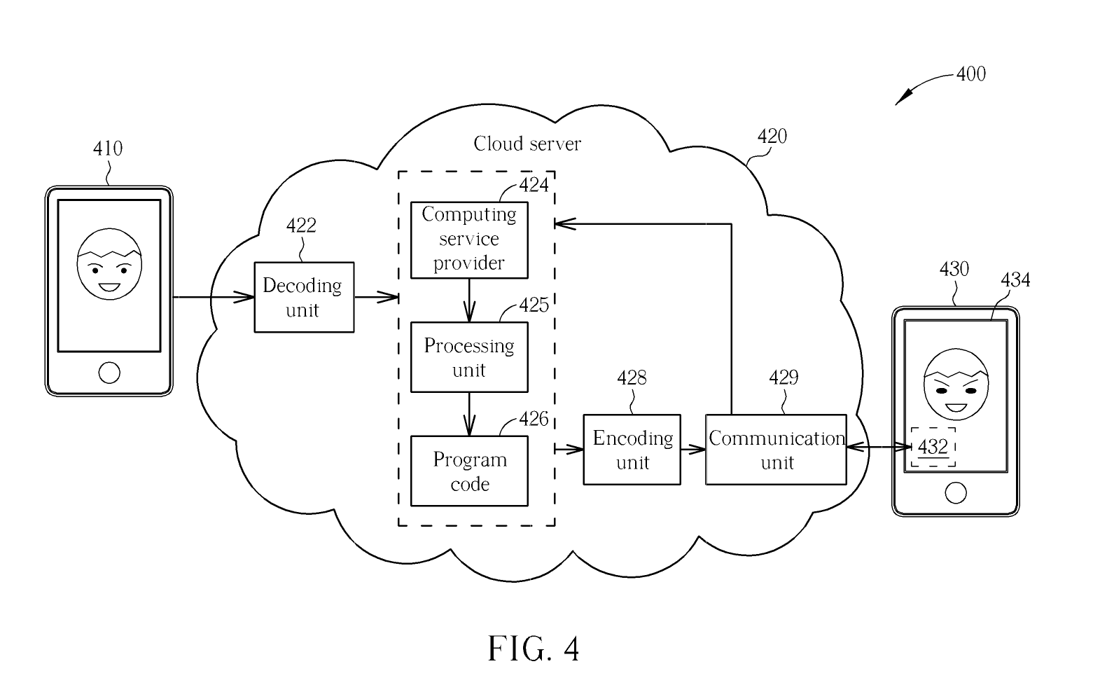

Please refer to FIG. 4, which shows a real-time communication system 400 according to another embodiment of the present invention. As shown in FIG. 4, the real-time communication system 400 comprises a client-end remote device 410, a cloud server 420 and a client-end mobile terminal 430, where the cloud server 420 comprises a decoding unit 422, a computing service provider 424, a processing unit 425, a program code 426, an encoding unit 428 and a communication unit 429; and the client-end mobile terminal 430 comprises a communication unit 432 and a display unit 434.

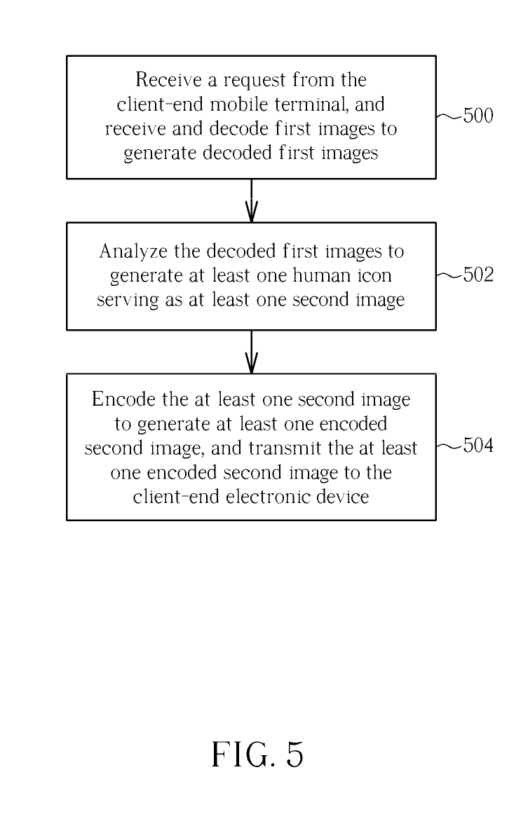

Please refer to FIG. 4 and FIG. 5 together. FIG. 5 is a flowchart of a real-time communication method according to another embodiment of the present invention. The steps shown in FIG. 5 are performed by the processing unit 425 when the program code 426 is executed by the processing unit 425. Referring to FIG. 5, the flow is described as follows:

In Step 500, the communication unit 429 receives a request from the client-end mobile terminal 430 for a computing service that allows the client-end mobile terminal 430 to use a plurality of first images provided by client-end remote device 410, and the decoding unit 422 receives and decodes a plurality of first images captured by the camera of the first client-end remote device 410 via a network to generate a plurality of decoded first images, where the first images include photographed data about a user of the first client-end electronic device 410. Then, in Step 502, the processing unit 425 analyzes the decoded first images to generate at least one human icon serving as at least one second image. In one embodiment, the processor performs recognition of a face characteristic, a body figure, a body action or a body posture upon the first images to generate a three-dimensional (3D) human icon similar to that used in the film ‘Avatar’. Then, in Step 504, the encoding unit 428 encodes the second image to generate an encoded second image, and transmits the encoded second image to the second client-end mobile terminal 430 via the network, where the second client-end mobile terminal 430 merely decodes the encoded second image and directly displays the second image without processing or modifying the second image.

In the embodiments shown in FIG. 4, the cloud server 420 can convert/modify the user image to generate the second image such as 3D avatar, and the second client-end mobile terminal 430 shows 3D avatar in stead of the user image of the first client-end remote device 410 for social networking application.

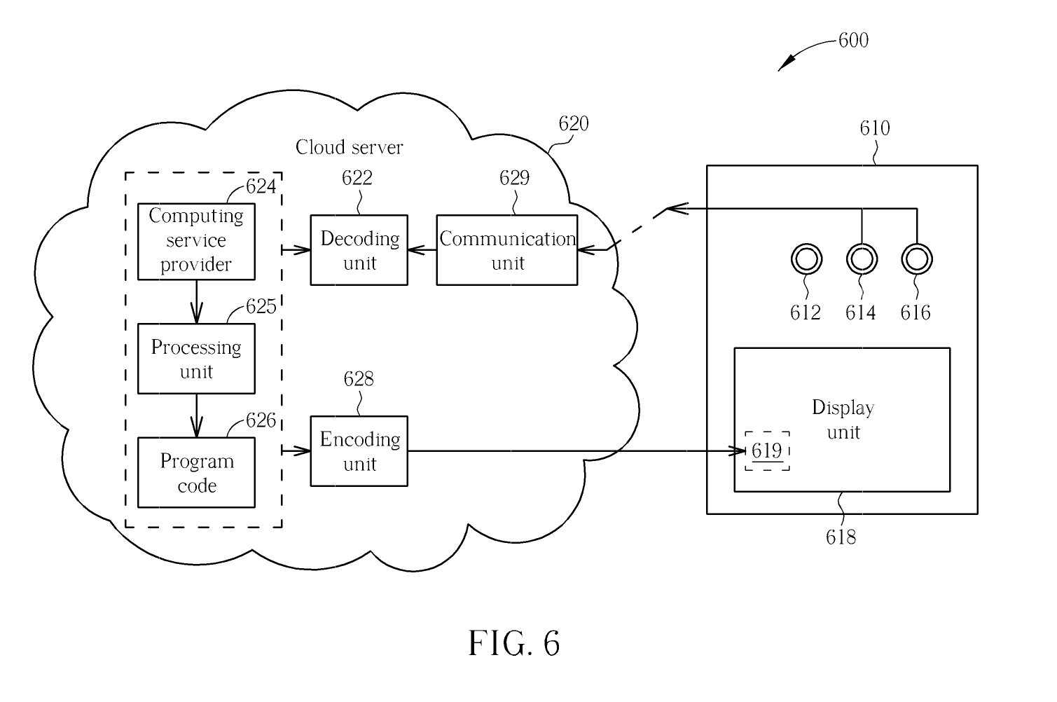

Please refer to FIG. 6, which shows a real-time communication system 600 according to another embodiment of the present invention. As shown in FIG. 6, the real-time communication system 600 comprises a client-end mobile terminal 610 and a cloud server 620, where the client-end mobile terminal 610 comprises a infrared emitter 612, a depth image camera 614, a color image camera 616, a display unit 618 and a communication unit 619; and the cloud server 620 comprises a decoding unit 622, a computing service provider 624, a processing unit 625 and a program code 626, an encoding unit 628 and a communication unit 629. In addition, in this embodiment, the client-end mobile terminal 610 is a media gamer, and the cloud server 620 provides motion-based gaming control.

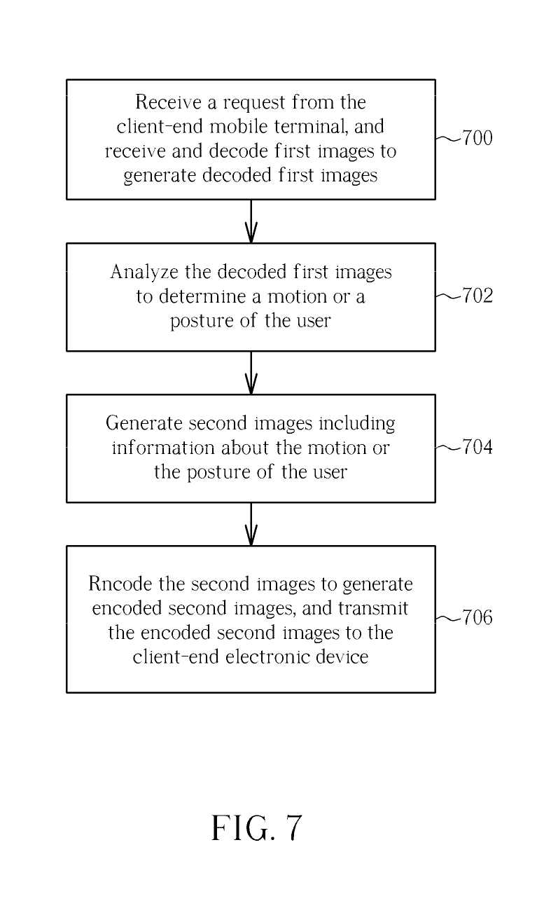

Please refer to FIG. 6 and FIG. 7 together. FIG. 7 is a flowchart of a real-time communication method according to another embodiment of the present invention. The steps shown in FIG. 7 are performed by the processing unit 625 when the program code 626 is executed by the processing unit 625. Referring to FIG. 7, the flow is described as follows:

In Step 700, the communication unit 629 receives a request from the client-end mobile terminal 610 for a computing service that allows the client-end mobile terminal 610 to use a plurality of first images provided by the depth image camera 614 and the color image camera 616, and the decoding unit 622 receives and decodes a plurality of first images captured by the camera of the first client-end mobile terminal 610 via a network to generate a plurality of decoded first images, where the first images are simultaneously captured from the depth image camera 614 and the color image camera 616, respectively, and the first images include photographed data about a user of the client-end mobile terminal 610. Then, in Step 702, the processing unit 625 analyzes the decoded first images to determine a motion or a posture of the user. Then, in Step 704, the processing unit 625 generates second images including information about the motion or the posture of the user. Then, in Step 706, the encoding unit 628 encodes the second images to generate encoded second images, and transmits the encoded second images to the client-end mobile terminal 610 via the network, where the client-end mobile terminal 610 merely decodes the at least one encoded second image and directly displays the second images without processing or modifying the second image.

In addition, although the infrared emitter 612, the depth image camera 614, the color image camera 616, the display unit 618 and the communication unit 619 are built in a single electronic device show in FIG. 6, it is not meant to be a limitation of the present invention. In other embodiments, the infrared emitter 612, the depth image camera 614, the color image camera 616 can be integrated as a remote device, and the display unit 618 and the communication unit 619 can be integrated as a mobile terminal different from the remote device. This alternative design should fall within the scope of the present invention.

In the embodiments shown in FIG. 7, the cloud server 620 can finish all the motion or posture detection and analysis, and generate the second image that shows the motion or the posture of the user. Therefore, the client-end mobile terminal 610 does not need a powerful processor to analyze the motion or the posture of the user, and the manufacturing cost of the client-end mobile terminal 610 can be decreased.

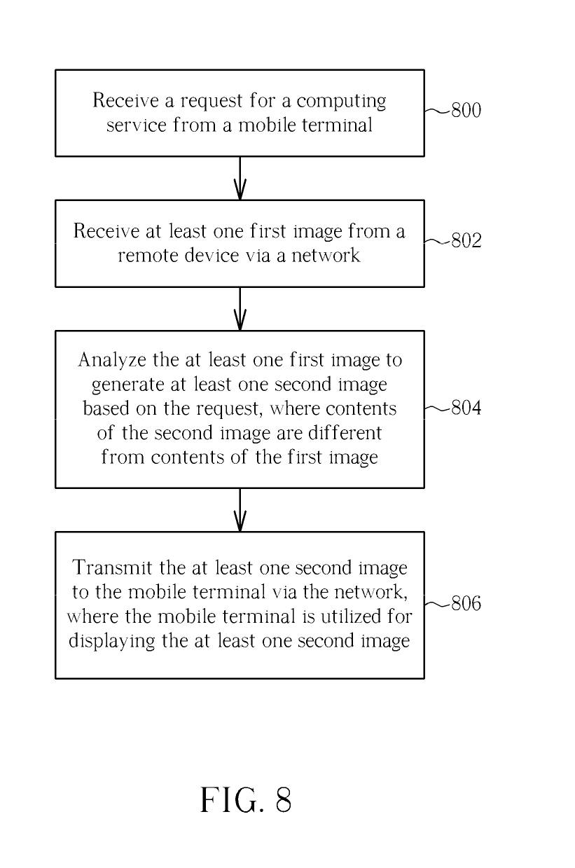

Briefly summarized, in the real-time communication method of the present invention, the cloud server receives and analyzes the first images from a remote device to generate second images to a mobile terminal, where the second images include all the required information, and the remote device and the mobile terminal can be the same device or different devices. Therefore, the mobile terminal can directly show the second images and does not need a powerful processor to process the data. Furthermore, the general concepts of the real-time communication method of the present invention are illustrated in FIG. 8, and the flow of FIG. 8 is as follows:

Step 800: Receive a request for a computing service from a mobile terminal.

Step 802: Receive at least one first image from a remote device via a network.

Step 804: Analyze the at least one first image to generate at least one second image based on the request, where contents of the second image are different from contents of the first image.

Step 806: Transmit the at least one second image to the mobile terminal via the network, where the mobile terminal is utilized for displaying the at least one second image.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A cloud server, comprising:
a computing service provider configured to provide a computing service;
a communication unit configured to receive from a mobile terminal a request for the computing service that allows the mobile terminal to use at least one first image provided by a remote device supporting the computing service; and
a processing unit configured to generate at least one second image for transmitting to the remote device based on the request and the at least one first image.

2. The cloud server of claim 1, wherein the remote device is a camera, the at least one first image contains photographed data about a real-time street image captured by the camera, and the processing unit analyzes the at least one first image to determine whether a traffic event occurs at a position where the camera is disposed to generate the at least one second image including information about the traffic event and the position of the camera.

3. The cloud server of claim 1, wherein the processing unit receives a plurality of first images from a plurality of remote devices, respectively, where the remote devices are a plurality of cameras, respectively, the first images are respectively captured by the cameras, and each of the first images contains photographed data about a real-time street image; and the processing unit analyzes the first images to determine an optimal path from a source to a destination, and generates the at least one second image including information about the optimal path.

4. The cloud server of claim 1, wherein the at least one first image contains an image of a user of the remote device, and the processing unit analyzes the at least one first image to generate a human icon serving as the at least one second image.

5. The cloud server of claim 4, wherein the processing unit performs recognition of a face characteristic, a body figure, a body action or a body posture upon the at least one first image to generate a three-dimensional (3D) human icon serving as the at least one second image.

6. The cloud server of claim 1, wherein the remote device comprises two cameras, and the processing unit receives at least two first images simultaneously captured from the two cameras, respectively, and analyzes the at least two first images to generate at least one second image.

7. The cloud server of claim 6, wherein the two first images comprises a color image and a depth image.

8. The cloud server of claim 7, wherein each of the two first images contains an image of a user of the source electronic device, and the processing unit analyzes the at least two first images to determine a motion or a posture of the user, and generates the at least one second image including information about the motion or the posture of the user.

9. A real-time communication method, comprising:
receiving a request for a computing service from a mobile terminal;
receiving at least one first image from a remote device via a network;
analyzing the at least one first image to generate at least one second image according to the request, where contents of the second image are different from contents of the first image; and
transmitting the at least one second image to the mobile terminal.

10. The real-time communication method of claim 9, wherein the step of analyzing the at least one first image to generate the at least one second image comprises:
analyzing the at least one first image which contains photographed data about a real-time street image captured by the remote device to determine whether a traffic event occurs at a position where the remote device is disposed; and
generating the at least one second image including information about the traffic event and the position of the remote device.

11. The real-time communication method of claim 9, wherein the step of analyzing the at least one first image to generate the at least one second image comprises:
analyzing the at least one first image contains photographed data about a real-time street image captured by a plurality of remote devices to determine an optimal path from a source to a destination; and
generating the at least one second image including information about the optimal path.

12. The real-time communication method of claim 9, wherein the step of analyzing the at least one first image to generate the at least one second image comprises:
analyzing the at least one first image which contains an image of a user of the remote device to generate a human icon serving as the at least one second image.

13. The real-time communication method of claim 12, wherein the step of analyzing the at least one first image to generate the human icon serving as the at least one second image comprises:
performing recognition of a face characteristic, a body figure, a body action or a body posture upon the at least one first image to generate a three-dimensional (3D) human icon serving as the at least one second image.

14. The real-time communication method of claim 9, wherein the step of receiving the at least one first image from the remote device comprises:
receiving at least two first images simultaneously captured by two cameras in the remote device.

15. The real-time communication method of claim 14, wherein the two first images comprises a color image and a depth image.

16. The real-time communication method of claim 15, wherein each of the two first images contains an image of a user of the remote device, and the step of analyzing the at least two first images to generate at least one second image comprises:
analyzing the at least two first images to determine a motion or a posture of the user; and
generating the at least one second image including information about the motion or the posture of the user.

17. A mobile terminal, comprising:
a communication unit configured to transmit a request for a computing service to a cloud server that allows the mobile terminal to use at least one first image provided by a remote device supporting the computing service and receive at least one second image generated in the cloud server based on the request and the at least one first image; and
a display unit configured to display the at least one second image.

18. The mobile terminal of claim 17, wherein the at least one first image contains photographed data about a real-time street image captured by a camera, and the real-time street image is analyzed to determine whether a traffic event occurs at a position where the camera is disposed, and the at least one second image includes information about the traffic event and the position of the camera.

19. The mobile terminal of claim 17, wherein the at least one first image is analyzed to generate a human icon serving as the at least one second image.

20. The mobile terminal of claim 17, wherein the remote device comprises two cameras, the communication unit receives at least two first images simultaneously captured from the two cameras, respectively, and the at least two first images are analyzed to generate the at least one second image.
